(19) United States
(12) Patent Application Publication
(10) Pub. No.: US 2025/0261166 A1
(43) Pub. Date: Aug. 14, 2025

(54) METHOD AND APPARATUS FOR PAGING PROCEDURE IN A WIRELESS COMMUNICATION SYSTEM

(71) Applicant: Samsung Electronics Co., Ltd., Suwon-si (KR)

(72) Inventors: Daejin KIM, Suwon-si (KR); Suyoung KIM, Suwon-si (KR); Myungchun KWAK, Suwon-si (KR); Dongho NAM, Suwon-si (KR)

(21) Appl. No.: 19/192,988

(22) Filed: Apr. 29, 2025

Related U.S. Application Data
(63) Continuation of application No. PCT/KR2023/016744, filed on Oct. 26, 2023.

(30) Foreign Application Priority Data
Nov. 7, 2022 (KR) 10-2022-0147255
Nov. 21, 2022 (KR) 10-2022-0156597

(51) Int. Cl. H04W 68/02; H04L 41/16; H04W 60/04

(52) U.S. Cl. CPC H04W 68/02; H04L 41/16; H04W 60/04

(57) ABSTRACT

A method for identifying a base station to which a network node is to transmit a paging message in a wireless communication system is provided. The method includes receiving, from multiple terminals registered with an access and mobility management function (AMF) entity, mobility data related to movement frequencies of the multiple terminals, based on a learning algorithm trained to derive a candidate paging area based on the mobility data, and mobility data for a first period among the mobility data, deriving a first candidate paging area, determining reliability of the derived first candidate paging area based on test data for the first period, identifying another base station to receive a paging message transmitted from the network node, and transmitting, to the at least one base station, the paging message, wherein the test data for the first period comprises mobility data related to the multiple terminals after the first period.

### CROSS-REFERENCE TO RELATED APPLICATION(S)

This application is a continuation application, claiming priority under 35 U.S.C. § 365(c), of an International application No. PCT/KR2023/016744, filed on Oct. 26, 2023, which is based on and claims the benefit of a Korean patent application number 10-2022-0147255, filed on Nov. 7, 2022, in the Korean Intellectual Property Office, and of a Korean patent application number 10-2022-0156597, filed on Nov. 21, 2022, in the Korean Intellectual Property Office, the disclosure of each of which is incorporated by reference herein in its entirety.

### BACKGROUND

### 1. Field

The disclosure relates to a wireless communication system. More particularly, the disclosure relates to a method and an apparatus for reducing paging load.

### 2. Description of Related Art

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems.

In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (COMP), reception-end interference cancellation and the like.

In the 5G system, hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed. With the advance of wireless communication systems as described above, various services can be provided, and accordingly there is a need for schemes to smoothly provide these services. More particularly, there is a need for a technology to support services newly requested in a wireless communication system.

Recently, with the development of communication systems, methods for reducing the number of paging messages and increasing a paging success rate in a paging procedure are being sought. More particularly, research is being conducted continuously to improve a paging procedure based on a larger amount of data by applying a machine learning algorithm. In addition, research is also being conducted in parallel with efforts to improve the aforementioned machine learning algorithm based on artificial intelligence (AI).

The above information is presented as background information only to assist with an understanding of the disclosure. No determination has been made, and no assertion is made, as to whether any of the above might be applicable as prior art with regard to the disclosure.

### SUMMARY

A machine learning algorithm based on mobility data of a terminal is proposed. Via the proposed algorithm, a paging area, which increases a paging success rate while minimizing the number of S1AP/NGAP paging messages that consume a significant portion of network resources, may be obtained.

Aspects of the disclosure are to address at least the above-mentioned problems and/or disadvantages and to provide at least the advantages described below. Accordingly, an aspect of the disclosure is to provide an apparatus and a method for reducing paging load by deriving an optimal paging area.

Another aspect of the disclosure is to provide a method and an apparatus for AI model-based performance evaluation for deriving an optimal paging area.

Additional aspects will be set forth in part in the description which follows and, in part, will be apparent from the description, or may be learned by practice of the presented embodiments.

In accordance with an aspect of the disclosure, a method for identifying a base station to which a network node is to transmit a paging message in a wireless communication system is provided. The method includes receiving, from multiple terminals registered with an access and mobility management function (AMF) entity, mobility data related to movement frequencies of the multiple terminals, based on a learning algorithm trained to derive a candidate paging area based on the mobility data, and mobility data for a first period among the mobility data, deriving a first candidate paging area, determining reliability of the derived first candidate paging area based on test data for the first period, based on the reliability, identifying at least one base station to receive a paging message transmitted from the network node, and transmitting, to the at least one base station, the paging message, wherein the test data for the first period comprises mobility data related to the multiple terminals after the first period.

In accordance with another aspect of the disclosure, a network node is provided. The network node includes a transceiver; a processor coupled with the transceiver; and memory storing instructions that, when executed by the processor, cause the network node to receive, from multiple terminals registered with an access and mobility management function (AMF) entity, mobility data related to movement frequencies of the multiple terminals, based on a learning algorithm trained to derive a candidate paging area based on the mobility data, and mobility data for a first period among the mobility data, derive a first candidate paging area, determine reliability of the derived first candidate paging area based on test data for the first period, based on the reliability, identify at least one base station to receive a paging message transmitted from the network node, and transmit, to the at least one base station, the paging message, wherein the test data for the first period includes mobility data related to the multiple terminals after the first period.

In accordance with another aspect of the disclosure, one or more non-transitory computer-readable storage media storing one or more computer programs including computer-executable instructions that, when executed by one or more processors of an electronic device individually or collectively, cause the electronic device to perform operations of identifying a base station to which a network node is to transmit a paging message in a wireless communication system is provided. The operations include receiving, from multiple terminals registered with an access and mobility management function (AMF) entity, mobility data related to movement frequencies of the multiple terminals, based on a learning algorithm trained to derive a candidate paging area based on the mobility data, and mobility data for a first period among the mobility data, deriving a first candidate paging area, determining reliability of the derived first candidate paging area based on test data for the first period, based on the reliability, identifying at least one base station to receive a paging message transmitted from the network node, and transmitting, to the at least one base station, the paging message, wherein the test data for the first period comprises mobility data related to the multiple terminals after the first period.

A method and an apparatus according to various embodiments of the disclosure reduces paging load by sequentially attempting to page base stations to which a terminal is highly likely to move.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment of the disclosure;

FIG. 2 illustrates a structure of a UE in a wireless communication system according to an embodiment of the disclosure;

FIG. 3 illustrates a structure of a base station in a wireless communication system according to an embodiment of the disclosure;

FIG. 4 illustrates a structure of an access and mobility management function (AMF) according to an embodiment of the disclosure;

FIG. 5 illustrates mobility of a UE between base stations according to an embodiment of the disclosure;

FIG. 6 illustrates a transition probability matrix according to an embodiment of the disclosure;

FIG. 7 illustrates a smart paging algorithm according to an embodiment of the disclosure;

FIG. 8 illustrates candidate tracking areas (TAs) via machine learning according to an embodiment of the disclosure;

FIG. 9 illustrates performance evaluation results according to an embodiment of the disclosure;

FIG. 10 illustrates a configuration of a network entity for smart paging according to an embodiment of the disclosure;

FIG. 11 illustrates an operation sequence of an AMF for smart paging according to an embodiment of the disclosure; and

FIG. 12 illustrates an artificial intelligence (AI)-based performance evaluation sequence according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the art and not associated directly with the disclosure will be omitted. Such an omission of unnecessary descriptions is intended to prevent or reduce obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. In describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit comprising circuitry, a base station controller comprising circuitry, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the example embodiments may also be applied to other communication systems having similar technical backgrounds or channel types. Examples of such communication systems may include 5^{th} generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the example embodiments may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description, some of terms and names defined in the 3rd generation partnership project long term evolution (3GPP LTE)-based communication standards (e.g., standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

The disclosure relates to a machine learning method and apparatus for reducing paging load in a wireless communication system. Specifically, the disclosure describes a technique in which, in a wireless communication system, a network node (e.g., a mobility management entity (MME) or an access and mobility management function (AMF)) that manages mobility of a UE transmits paging messages sequentially to base stations to which the UE is highly likely to move, thereby reducing paging load. Hereinafter, for convenience of description, a base station to which a UE is expected to move, i.e., a base station that transmits a paging message, is referred to and described as a paging base station.

Advantageous effects obtainable from the disclosure may not be limited to the above-mentioned effects, and other effects which are not mentioned may be clearly understood from the following descriptions by those skilled in the art to which the disclosure pertains.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

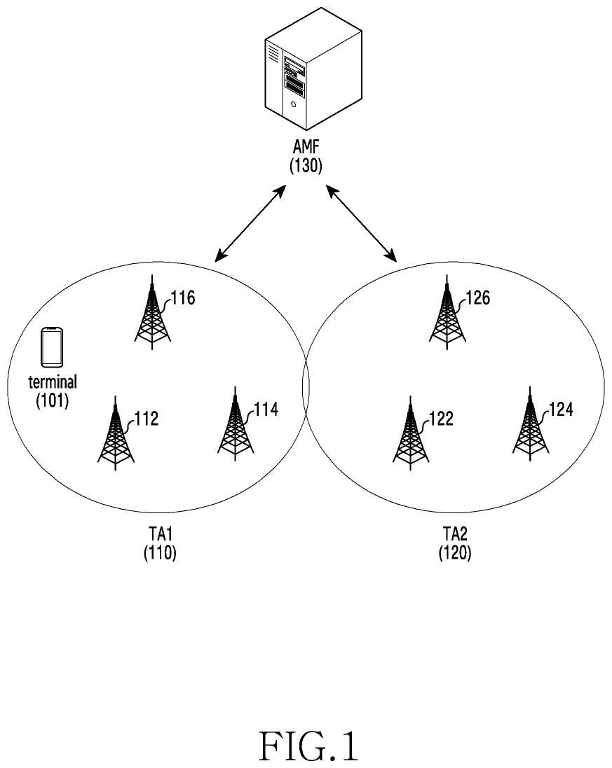

FIG. 1 illustrates a wireless communication system according to an embodiment of the disclosure.

Referring to FIG. 1, it illustrates an AMF 130, a base station 112, a base station 114, a base station 116, a base station 122, a base station 124, a base station 126, and a UE 140, as some of nodes using a wireless channel in the wireless communication system.

The UE 140 is a device used by a user and may perform communication via an access network, i.e., a wireless channel established with respect to the base station 112, 114, 116, 122, 124, or 126. In some cases, the UE 140 may be operated without user involvement. For example, at least one UE 140 is a device that performs machine type communication (MTC) and may not be carried by a user. The UE 140 may be referred to as “terminal,” “user equipment (UE),” “mobile station,” “subscriber station,” “customer premises equipment (CPE),” “remote terminal,” “wireless terminal,” “vehicle terminal,” “user device,” or other terms having equivalent technical meanings.

The base station 112, 114, 116, 122, 124, or 126 corresponds to a network infrastructure that provides wireless access. The base station 112, 114, 116, 122, 124, or 126 has coverage defined as a certain geographic area based on a distance in which a signal may be transmitted. Hereinafter, the term “coverage” used may refer to a service coverage area provided by the base station 112, 114, 116, 122, 124, or 126. The base station 112, 114, 116, 122, 124, or 126 may cover one cell or cover multiple cells. Here, multiple cells may be distinguished based on supported frequencies and sector areas that are covered.

The base station 112, 114, 116, 122, 124, or 126 may be referred to as, in addition to base station, “access point (AP),” “eNodeB (eNB),” “5^{th} generation node (5G node),” “5G NodeB,” “next generation node B (gNB),” “wireless point,” “transmission/reception point (TRP),” “distributed unit (DU),” “radio unit (RU),” “remote radio head (RRH),” or other terms having equivalent technical meanings. According to various embodiments of the disclosure, the base station 112, 114, 116, 122, 124, or 126 may be connected to one or more TRPs. The base station 112, 114, 116, 122, 124, or 126 may, via one or more TRPs, transmit a downlink signal to a user equipment (UE) 101 or receive an uplink signal.

The AMF 130 may provide a function for managing access and mobility of the UE, and one UE may be connected to one AMF by default. Specifically, the AMF 130 may perform at least one function among signaling between core network nodes for mobility between 3^{rd} generation partnership project (3GPP) access networks, a CP interface (N2 interface) between radio access networks (e.g., 5G radio access networks (RANs)), NAS signaling with the UE 101, identification of an SMF, and transferring and providing a session management message between the UE and the SMF. Some or all of the functions of the AMF may be supported within a single instance of one AMF.

The UE 101 may transmit or receive a message to or from the AMF 130 via NAS signaling. NAS signaling may indicate a functional layer for exchanging traffic messages and signaling between a UE and a core network in a 5G system (5GS) protocol stack. In a NAS layer, the UE 101 may transmit a message to the AMF or receive a message from the AMF via the base station. In this case, the base station may transfer a message to the UE 101 or the AMF without interpreting the message. Mobility of the UE 101 may be supported via NAS signaling.

Hereinafter, although described as the AMF, another wireless communication system environment may be considered in addition to the NR environment. According to an embodiment of the disclosure, various embodiments of the disclosure may be applied to a wireless environment where a long-term evolution (LTE) communication system is used. In this case, as an entity for mobility management, a mobility management entity (MME) may be used instead of the AMF. For example, AMF operations of the disclosure described below may be performed by the MME.

The communication system according to various embodiments of the disclosure may include a standalone (SA) deployment structure for performing communication only with 5G communication entities, or may include a non-standalone (NSA) deployment structure using 4G entities and 5G entities for 5G communication. In addition, according to an embodiment of the disclosure, the communication system of the disclosure may include a network deployment structure including 4G entities. Hereinafter, the disclosure describes embodiments assuming a 5G communication network. However, if the same concept is also applicable to other systems within a scope that can be understood by a person having ordinary technical skills, other systems may be applied.

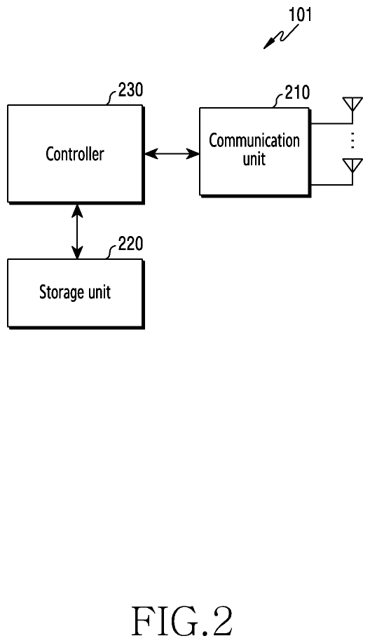

FIG. 2 illustrates a structure of a UE according to an embodiment of the disclosure.

The structure illustrated in FIG. 2 may be understood as a structure of the UE 101 in FIG. 1. As used herein, the term “ . . . unit”, “-er”, or the like refers to a unit configured to process at least one function or operation, and may be implemented as hardware, software, or a combination of hardware and software.

Referring to FIG. 2, the UE may include a communication unit 210, a storage unit 220, and a controller 230.

The communication unit 210 performs functions for transmitting/receiving signals through radio channels. For example, the communication unit 210 may performs functions of conversion between baseband signals and bitstrings according to the physical layer specifications of the system. For example, during data transmission, the communication unit 210 may encode and modulate a transmitted bitstring to generate complex symbols. In addition, during data reception, the communication unit 210 may demodulate and decode a baseband signal to restore a received bitstring. In addition, the communication unit 210 up-converts a baseband signal to an RF band signal, transmits the same through an antenna, and down-converts an RF band signal received through the antenna to a baseband signal. To this end, the communication unit 210 may include a transmission filter, a reception filter, an amplifier, a mixer, an oscillator, a digital to analog converter (DAC), an analog to digital converter (ADC), and the like.

In addition, the communication unit 210 may include multiple transmission/reception paths. Furthermore, the communication unit 210 may include an antenna unit. The communication unit 210 may include at least one antenna array configured by multiple antenna elements. In terms of hardware, the communication unit 210 may include a digital circuit and an analog circuit (e.g., a radio frequency integrated circuit (RFIC)). The digital circuit and the analog circuit may be implemented as a single package. In addition, the communication unit 210 may include multiple RF chains. The communication unit 210 may perform beamforming. In order to assign directivity based on configurations of the controller 230 to a signal to be transmitted/received, the communication unit 210 may apply a beamforming weight to the signal.

In addition, the communication unit 210 may transmit/receive signals. To this end, the communication unit 210 may include at least one transceiver. In addition, the communication unit 210 may receive a downlink signal. The downlink signal may include a synchronization signal, a reference signal, a configuration message, control information, downlink data, etc. In addition, the communication unit 210 may transmit an uplink signal. The uplink signal may include a random access-related signal (e.g., a random-access preamble (RAP) or message 3 (Msg3)), a reference signal, a power headroom report (PHR), etc.

In addition, the communication unit 210 may include different communication modules for processing signals in different frequency bands. Furthermore, the communication unit 210 may include multiple communication modules in order to support multiple different radio access technologies. For example, the different radio access technologies may include Bluetooth low energy (BLE), wireless fidelity (Wi-Fi), Wi-Fi gigabyte (WiGig), a cellular network (e.g., long-term evolution (LTE)), new radio (NR), or the like. In addition, the different frequency bands may include super high frequency (SHF) bands (e.g., 2.5 GHz or 5 GHz bands), millimeter wave (mmWave) bands (e.g., 38 GHz or 60 GHz bands), etc. In addition, the communication unit 210 may use a radio-access technology of the same scheme on different frequency bands (e.g., an unlicensed band for licensed assisted access (LAA) and a citizen broadband radio service (CBRS) (e.g., 3.5 GHZ)).

The communication unit 210 may transmit and receive a signal as described above. Accordingly, all or part of the communication unit 210 may be referred to as a “transmitter”, a “receiver”, or a “transceiver”. In addition, as used in the following description, the meaning of “transmission and reception performed through a radio channel” may include the meaning that the above-described processing is performed by the communication unit % n.

The storage unit 220 may store data, such as a basic program, an application program, and configuration information for operations of the UE 101. The storage unit 220 may be configured by volatile memory, nonvolatile memory, or a combination of volatile memory and nonvolatile memory. In addition, the storage unit 220 may provide the stored data at the request of the controller 230.

The controller 230 may control the overall operation of the UE. For example, the controller 230 may transmit and receive a signal through the communication unit 210. In addition, the controller 230 may record data in the storage unit 220 and reads the data from the storage unit 220. In addition, the controller 230 may perform functions of protocol stacks required by communication specifications. To this end, the controller 230 may include at least one processor. The controller 230 may include at least one processor or micro-processor, or may be a part of a processor. In addition, a part of the communication unit 210 and the controller 230 may be referred to as a CP. The controller 230 may include various modules for performing communication. According to various embodiments of the disclosure, the controller 230 may control the UE to perform operations according to various embodiments as described below.

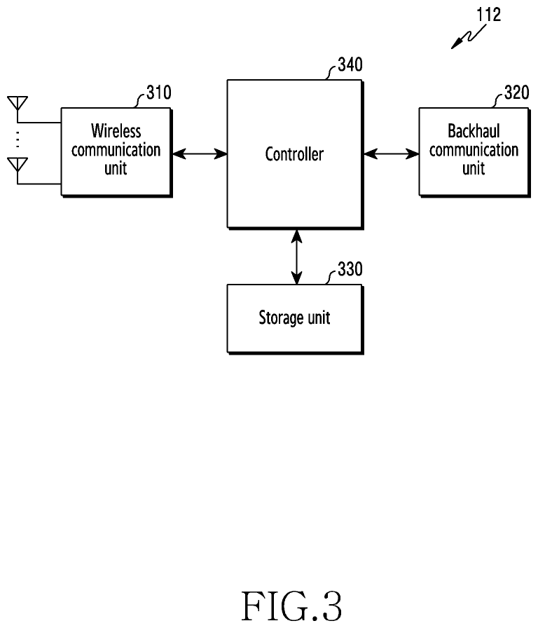

FIG. 3 illustrates a structure of a base station according to an embodiment of the disclosure.

The structure illustrated in FIG. 3 may be understood as a structure of the base station 112 in FIG. 1. As used herein, the term “ . . . unit”, “-er”, or the like refers to a unit configured to process at least one function or operation, and may be implemented as hardware, software, or a combination of hardware and software.

Referring to FIG. 3, the base station 112 may include a communication unit 310, a backhaul communication unit 320, a storage unit 330, and a controller 340.

The communication unit 310 performs functions for transmitting/receiving signals through radio channels. Accordingly, the communication unit 310 may be referred to as “wireless communication unit”. For example, the communication unit 310 may performs functions of conversion between baseband signals and bitstrings according to the physical layer specifications of the system. For example, during data transmission, the communication unit 310 may encode and modulate a transmitted bitstring to generate complex symbols. In addition, during data reception, the communication unit 310 may demodulate and decode a baseband signal to restore a received bitstring. In addition, the communication unit 310 up-converts a baseband signal to an RF band signal, transmits the same through an antenna, and down-converts an RF band signal received through the antenna to a baseband signal. To this end, the communication unit 310 may include a transmission filter, a reception filter, an amplifier, a mixer, an oscillator, a digital to analog converter (DAC), an analog to digital converter (ADC), or the like.

In addition, the communication unit 310 may include multiple transmission/reception paths. Moreover, the communication unit 310 may include at least one antenna array configured by multiple antenna elements. In terms of hardware, the communication unit 310 may include a digital unit and an analog unit, and the analog unit may include multiple sub-units according to operation power, frequencies, etc.

The communication unit 310 may transmit/receive signals. To this end, the communication unit 310 may include at least one transceiver. For example, the communication unit 310 may transmit a synchronization signal, a reference signal, system information, a configuration message, control information, data, etc. In addition, the communication unit 310 may perform beamforming.

The communication unit 310 may transmit and receive a signal as described above. Accordingly, all or part of the communication unit 310 may be referred to as a “transmitter”, a “receiver”, or a “transceiver”. In addition, as used in the following description, the meaning of “transmission and reception performed through a radio channel” may include the meaning that the above-described processing is performed by the communication unit 310.

The backhaul communication unit 320 provides an interface for performing communication with other nodes in the network. For example, the backhaul communication unit 320 may convert, into a physical signal, a bitstream transmitted from the base station 112 to another node, for example, another access node, another base station, a higher node, a core network, etc., and convert a physical signal received from another node into a bitstream.

The storage unit 330 may store data, such as a basic program, an application program, and configuration information for an operation of the base station 112. The storage unit 330 may include memory. The storage unit 330 may be configured by volatile memory, nonvolatile memory, or a combination of volatile memory and nonvolatile memory. In addition, the storage unit 330 may provide the stored data at the request of the controller 340.

The controller 340 may control the overall operation of the base station 112. For example, the controller 340 may transmit and receive a signal through the communication unit 310 or the backhaul communication unit 320. In addition, the controller 340 may record data in the storage unit 330 and reads the data from the storage unit 330. Furthermore, the controller 340 may perform functions of protocol stacks required by communication specifications. To this end, the controller 340 may include at least one processor.

The structure of the base station 112 illustrated in FIG. 3 is a merely an example of the base station, and examples of the base station for performing various embodiment of the disclosure are not limited to the structure illustrated in FIG. 3. For example, some elements may be added, omitted, or changed according to various embodiments.

In FIG. 3, the base station has been described as a single entity, but the disclosure is not limited thereto. In addition to the integrated deployment, the base station according to various embodiments of the disclosure may be implemented to construct an access network having a distributed deployment. According to an embodiment of the disclosure, the base station may be divided into a central unit (CU) and a digital unit (DU), the CU may be implemented to perform upper layer functions (e.g., packet data convergence protocol (PDCP) and radio resource control (RRC)), and the DU may be implemented to perform lower layer functions (e.g., medium access control (MAC) and physical (PHY)). The DU of the base station may form beam coverage on a radio channel.

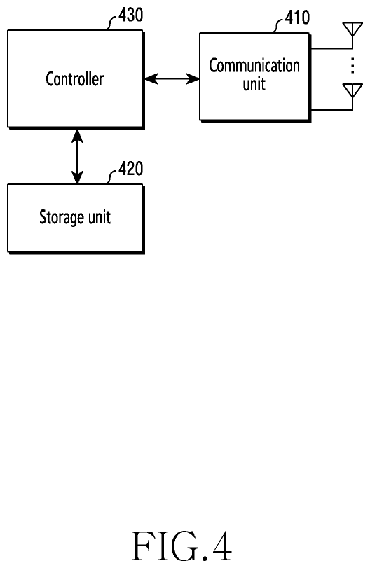

FIG. 4 illustrates a structure of an access and mobility management function (AMF) according to an embodiment of the disclosure.

The structure illustrated in FIG. 4 may be understood as a structure of the AMF 130 in FIG. 1. As used herein, the term “ . . . unit”, “-er”, or the like refers to a unit configured to process at least one function or operation, and may be implemented as hardware, software, or a combination of hardware and software.

Referring to FIG. 4, the AMF may include a communication unit 410, a storage unit 420, and a controller 430.

The communication unit 410 may perform functions for transmitting/receiving signals in a wired communication environment. The communication unit 410 may include a wired interface for a direct connection between devices through a transmission medium (e.g., copper wire or optical fiber). For example, the communication unit 410 may transfer electric signals to another device through a coper wire, or may perform conversion between electric signals and optical signals. The communication unit 410 may transmit/receive signals between network entities forming a core network according to the wired communication interface specifications.

The communication unit 410 performs functions for transmitting/receiving signals through radio channels. For example, the communication unit 410 may performs functions of conversion between baseband signals and bitstrings according to the physical layer specifications of the system. For example, during data transmission, the communication unit 410 may encode and modulate a transmitted bitstring to generate complex symbols. In addition, during data reception, the communication unit 410 may demodulate and decode a baseband signal to restore a received bitstring. In addition, the communication unit 410 up-converts a baseband signal to an RF band signal, transmits the same through an antenna, and down-converts an RF band signal received through the antenna to a baseband signal. To this end, the communication unit 410 may include a transmission filter, a reception filter, an amplifier, a mixer, an oscillator, a digital to analog converter (DAC), an analog to digital converter (ADC), etc.

The communication unit 410 may transmit and receive a signal as described above. Accordingly, all or part of the communication unit 410 may be referred to as a “transmitter”, a “receiver”, or a “transceiver”. In addition, as used in the following description, the meaning of “transmission and reception performed through a radio channel” may include the meaning that the above-described processing is performed by the communication unit % n.

The storage unit 420 may store data, such as a basic program, an application program, and configuration information for operations of the network entity. The storage unit 420 may be configured by volatile memory, nonvolatile memory, or a combination of volatile memory and nonvolatile memory. In addition, the storage unit 420 may provide data stored therein at the request of the controller 430.

The controller 430 may control the overall operation of the AMF. For example, the controller 430 may transmit and receive a signal through the communication unit 410. In addition, the controller 430 may record data in the storage unit 420 and reads the data from the storage unit 420. Furthermore, the controller 430 may perform functions of protocol stacks required by communication specifications. According to another implementation, the protocol stack may be included in the communication unit 410. To this end, the controller 430 may include at least one processor.

The AMF may be a network entity that manages mobility of the UE. The AMF may identify a location of the UE in units of tracking areas (TAs), i.e., a set of one or more cells. In a case of a radio resource control (RRC) connected state in which the UE is able to access the AMF, the AMF may identify the location of the UE in units of cells. In a case of an RRC inactive state of the UE introduced in the new radio (NR), the core network recognizes that the core and the UE have been connected, and radio access network (RAN) paging is performed, so that the AMF may also identify the location of the UE. However, if the UE is in an RRC idle state, the AMF identifies only a registered TA and is unable to identify the location of the UE so that the AMF may need to transmit a paging message to connect to the UE.

A paging method of the related art (e.g., paging order 3) is described below with reference to FIG. 1. In the description below, it may be assumed that a TAL includes TA1 110 and TA2 120.

The AMF 130 may transmit a first paging message to the base station 112 that the UE 101 is last connected to. If there is no response to the first paging message, the AMF 130 may transmit a second paging message to the base stations 112, 114, and 116 included in TA1 110 to which the base station 112 belongs. If there is no response to the second paging message, the AMF 130 may transmit a third paging message to the base stations 112, 114, 116, 122, 124, and 126 included in the TAL to which the base station 112 belongs. For example, the AMF may sequentially transmit paging messages to a base station (hereinafter, referred to as a reference base station) that has most recently transmitted a paging message, base stations belonging to a TA (hereinafter, referred to as a reference TA) of the reference base station, and base stations belonging to a TAL (hereinafter, referred to as a reference TAL) of the reference TA.

Referring to the paging method of the related art described above, there may be two signaling loads in mobility management of the UE, which are used in the core network. A first signaling load may be a tracking area update (TAU) load in which the UE informs about its location to the AMF. For example, if the number of cells included in a TA is small, energy consumption of the UE may be high due to frequent TAU. A second signaling load may be a paging load transmitted by the AMF to the UE. For example, if the number of base stations included in a TA is large, the number of paging messages (e.g., S1 application protocol (S1AP) or NG application protocol (NGAP)) may increase, resulting in large consumption of network resources. In other words, the TAU load and the paging load may be affected by a configuration of the TA, and may be in a trade-off relationship. Therefore, it is necessary to reduce resource waste by reducing the number of unnecessary paging message transmissions within the network.

Hereinafter, the disclosure relates to a method and an apparatus for reducing paging load by acquiring an optimal number of base stations (i.e., paging base stations) for paging message transmission for each stage. If paging attempts by all the paging base stations fail in corresponding stages, the AMF configures paging base stations again in a subsequent stage. In this case, since a range of paging base stations increases as stages progress, a design for which base station is to be configured as a paging base station in a specific stage may be required based on a total number of paging messages.

If a probability that the UE will move from a base station that has been last registered with the AMF to another base station is given, a minimum paging load may be obtained by sequentially attempting to page to base stations to which the UE is highly likely to move. However, since latency may increase as the number of paging attempts increases, a paging order of the disclosure may be limited according to an embodiment. Hereinafter, a paging order is described to be 3 as an example in the disclosure, but the paging order in embodiments of the disclosure are not limited thereto.

According to an embodiment of the disclosure, a network entity may be the AMF. Hereinafter, descriptions are provided for a procedure in which the number of paging messages generated by the AMF 130 is defined as an objective function, and the number of paging messages is minimized based on the objective function.

Hereinafter, an expression method used to describe various embodiments of the disclosure is described in Table 1.

TABLE 1

| Symbol | Meaning |
|---|---|
| gbⱼ | gNB j |
| ${A}_{j} = \{ {gb}_{{j}_{1}} , {gb}_{{j}_{2}} , ⋯ , {gb}_{{j}_{{n}_{j}}} \}$ | TA including gNB j, nⱼ is the number of gNBs included in Aⱼ |
| Lj = U_{l∈[m]}Aⱼₗ | TAL including gNB j, m is the number of TAs included in TAL j |
| h | Paging level |
| fⱼ^{[i]} | Failure probability at i-th paging level for gNB j |
| Dⱼ^{[i]} | Set of gNBs for i-th paging in gNB j |
| dⱼ^{[i]} | Number of gNBs for i-th paging in gNB j |
| cⱼ^{[i]} | Number of i-th paging attempts in gNB j |
| c^{[i]} | Number of i-th paging attempts, |
| | i.e., c^{[i]} = Σ_{j∈(1,2,···,M}} cⱼ^{[i]} |
| M | Number of gNBs registered in AMF |
| \|Lⱼ\| | Size of set Lⱼ (cardinality) |
| P_{j,k} | Probability of moving from gNB j to gNB k |
| Pⱼ | (P_{j,1},P_{j,2}, ··· , P_{j,M}) |
| P | (P₁; P₂; ··· ; P_{M}) |

The AMF 130 may acquire mobility data. According to an embodiment of the disclosure, the AMF 130 may acquire mobility data from multiple UEs registered with the AMF. For example, the mobility data may include data on actual movement frequencies at which all UEs registered with the AMF move from a specific base station to the same or different base stations.

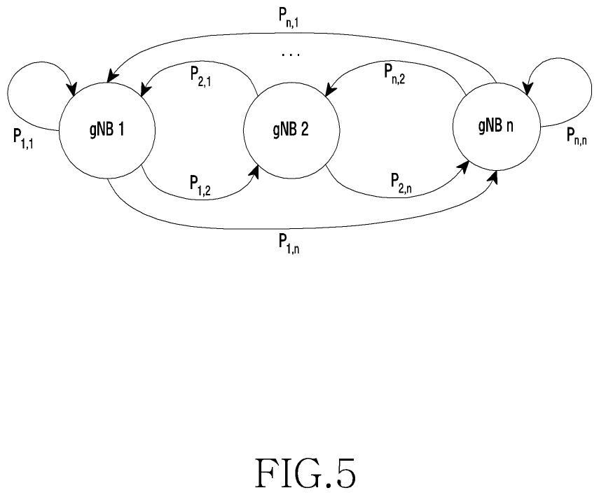

FIG. 5 illustrates mobility of a UE between base stations according to an embodiment of the disclosure.

Referring to FIG. 5, mobility of a UE between base stations may be described using equations. Mobility of a UE may refer to a probability that the UE moves between base stations. For example, a probability that a UE moves from one base station to one other base station among n base stations may be expressed as P. However, mobility of a UE is not limited to including only a probability that the UE moves from one base station to one other base station. Mobility of a UE may also include a probability that the UE moves within one base station belonging to n base stations.

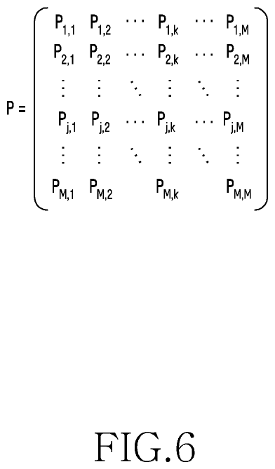

FIG. 6 illustrates a transition probability matrix according to an embodiment of the disclosure.

Referring to FIG. 6, a transition probability matrix may be shown. FIG. 6 may be a function that indicates, as a matrix, the mobility of the UE described above, that is, a probability that the UE moves from one base station to one other base station within n base stations, and a probability that the UE moves within one base station.

The AMF 130 may acquire a movement probability. According to an embodiment of the disclosure, the AMF 130 may acquire a movement probability based on a Markov model. According to an embodiment of the disclosure, the AMF 130 may acquire a movement probability of the UE, based on acquired mobility data. For example, when moving from base station j to base station k, a probability thereof may be expressed as P_{j,k}. According to an embodiment of the disclosure, the AMF 130 may acquire movement probability matrix P based on the acquired mobility data.

According to an embodiment of the disclosure, the AMF 130 may acquire a sequence for a probability that the UE moves from base station j, which has been last registered with the AMF 130, to base station k. The sequence for the probability that the UE moves from base station j to base station k may be expressed as {P_{j,k}}ₖ₌₁^{M}. Base station j that has been last registered with the AMF 130 may be a base station to which the UE in an RRC connected state has been connected before switching to an RRC idle state. Base station j that has been last registered with the AMF 130 may be a base station to which the UE in an RRC inactive state has been connected before switching to an RRC idle state.

According to an embodiment of the disclosure, the AMF 130 may acquire a subsequence excluding a case where the UE does not move from base station j. The subsequence may be expressed as {P_{j,k}_{ₗ}}l=1^{M-1}. According to an embodiment of the disclosure, subsequence {P_{j,k}_{ₗ}}ₗ₌₁^{M-1} may be a sequence sorted in descending order (i.e., P_{j,k}_{₁}≥P_{j,k}_{₂}≥ . . . P_{j,k}_{_{M-1}}, kₗ≠j). Based on acquired subsequence {P_{j,k}_{ₗ}}ₗ₌₁^{M-1}, when the UE leaves base station j, a probability of moving to base station kₗ may be determined. For example, when the UE leaves base station j, the probability (Q_{j,k}_{ₗ}) of moving to base station kₗ may be expressed as the following equation.

$${Q}_{j , {k}_{l}} = \{ \begin{matrix}\frac{{P}_{j , {k}_{l}}}{1 - {P}_{j , j}} , & if {P}_{j , j} \neq 1 \\ 0 , & if {P}_{j , j} = 1\end{matrix} \qquad Equation 1$$

In Equation 1, 1−P_{j,j} may indicate the probability of leaving base station j. For example, since a first paging message is transmitted only to base station j, 1−P_{j,j} may indicate a probability (fⱼ^{[1]}) that first paging fails.

According to an embodiment of the disclosure, Q_{j,k}_{ₗ} may be a sequence sorted in descending order (i.e., Q_{j,k}_{₁}≥Q_{j,k}_{₂}≥ . . . Q_{j,k}_{_{M-1}}). For example, since P_{j,K}_{ₗ} is a sequence sorted in descending order, Q_{j,k}_{ₗ} may also be a sequence sorted in descending order. A failure probability of a second paging may be expressed using Q_{j,k}_{ₗ} sorted in descending order. For example, when defined as Qⱼ(k)=Σᵣ₌₁^{k}Q_{j,r}(Qⱼ(0)=0, k∈{1,2, . . . , M−1}, the failure probability of the second paging (fⱼ^{[2]}) may be expressed as the following equation.

$${f}_{j}^{[ 2 ]} ( x ) = \{ \begin{matrix}1 - {Q}_{j} ( x ) , & if x ∈ \{ 1 , 2 , … , M - 1 \} \\ 0 , & if x ∈ \{ M , M + 1 , … \}\end{matrix} \qquad Equation 2$$

fⱼ^{[2]} is a function defined on a set of non-negative integers. For analysis, continuation extension of function f̅ⱼ^{[2]} of fⱼ^{[2]} may be defined as the following equation.

$${\overline{f}}_{j}^{[ 2 ]} ( x ) = \{ \begin{matrix}1 , & if x = 0 \\ - {Q}_{j , k} ( x - k ) - {Q}_{j} ( k ) + 1 , & if k - 1 < x \leq k \\ 0 , & if x > M - 1\end{matrix} \qquad Equation 3$$

In Equation 3, k∈{1,2, . . . , M−1}, j∈{1,2, . . . , M−1}, and l∈{1,2, . . . , M−1} may be satisfied. Therefore, fⱼ^{[2]} may be a strictly decreasing function in interval [0, M−1]. In addition, referring to Equation 4 below, fⱼ^{[2]} may be a convex function.

$${\overline{f}}_{j}^{[ 2 ]} ( x ) = {max}_{k ∈ \{ 1 , 2 , … , M \}} \{ - {Q}_{j , k} x - {Q}_{j} ( k ) + {kQ}_{j , k} + 1 \} \qquad Equation 4$$

The AMF 130 may determine an objective function. According to an embodiment of the disclosure, the AMF 130 may determine an objective function based on a movement probability. According to an embodiment of the disclosure, the objective function may indicate the number of paging messages transmitted by the AMF 130. For example, a generalized objective function (F(D)) may be defined as the following equation.

$$ℱ ( D ) = {\sum }_{j ∈ \{ 1 , 2 , … , M \}} ( {\sum }_{í ∈ \{ 1 , 2 , … , h \}} {c}_{j}^{[ i ]} \vert {D}_{j}^{[ i ]} \vert ) \qquad Equation 5$$

Here, cⱼ^{[i+1]}=cⱼ^{[i]}cⱼ^{[i]}(Dⱼⁱ) may be defined. Each variable may be defined according to Table 1.

Base stations selected for paging may be determined from the definition of {Q_{j,k}_{ₗ}}ₗ₌₁^{M-1} (e.g., being sorted in descending order from gNBs with a high movement probability). Therefore, when the number of base stations to transmit a paging message in each paging order (h) is determined, the number of base stations to transmit a paging message may be determined. Hereinafter, an embodiment of the disclosure is described using, as an example, a case where a paging order is 3 (i.e., h=3).

Referring to aforementioned Equations 1 to 5, the number of paging messages transmitted by the AMF 130 in paging orders 2 and 3 may be defined as the following equation.

$${c}_{j}^{[ 2 ]} = {c}_{j}^{[ 1 ]} {f}_{j}^{[ 1 ]} ( {D}_{j}^{[ 1 ]} ) = {c}_{j}^{[ 1 ]} ( 1 - {P}_{j , j} ) \qquad Equation 6$$

Here, since the AMF 130 transmits first paging only to base station j, Dⱼ^{[i]}=1 may be satisfied. If the first paging fails, second paging is performed, so that cⱼ^{[2]} may be determined based on fⱼ^{[1]}.

$$Equation 7$$

$${c}_{j}^{[ 3 ]} = {c}_{j}^{[ 2 ]} {f}_{j}^{[ 2 ]} ( {D}_{j}^{[ 2 ]} ) = {c}_{j}^{[ 1 ]} {f}_{j}^{[ 1 ]} ( {D}_{j}^{[ 1 ]} ) {f}_{j}^{[ 2 ]} ( {D}_{j}^{[ 2 ]} ) = {c}_{j}^{[ 1 ]} ( 1 - {P}_{j , j} ) {\overline{f}}_{j}^{[ 2 ]} ( {d}_{j} )$$

If the second paging fails, third paging is performed, so that cⱼ^{[3]} may be determined based on fⱼ^{[2]}. Referring to aforementioned Equations 6 and 7, the objective function (F(d)) indicating the number of paging messages transmitted by the AMF 130 up to paging order 3 may be defined as the following equation.

$$Equation 8$$

$$\begin{matrix}ℱ ( d ) = {\sum }_{j ∈ \{ 1 , 2 , … , M \}} {ℱ}_{j} ( {d}_{j} ) \\ = {\sum }_{j ∈ \{ 1 , 2 , … , M \}} {c}_{j}^{[ 1 ]} ( 1 + ( 1 - {P}_{j , j} ) ( {d}_{j} + 1 ) + ( 1 - {P}_{j , j} ) {\overline{f}}_{j}^{[ 2 ]} ( {d}_{j} ) \vert {L}_{j} \vert )\end{matrix}$$

Since the base stations are sorted in descending order starting from a base station with a highest mobility probability, if the AMF 130 determines the number (dⱼ) of base stations to transmit a paging message in paging order 2, the base stations to transmit a paging message, i.e., the paging base stations, may be identified.

According to an embodiment of the disclosure, in order to determine the number (di) of base stations to transmit a paging message, the following equation may be defined.

$$Equation 9$$

$${g}_{j} ( x ) = \{ \begin{matrix}{c}_{j}^{[ 1 ]} ( 1 - {P}_{j , j} ) ( 1 - {Q}_{j , k} ) \vert {L}_{j} \vert , & if k - 1 < x < k \\ {c}_{j}^{[ 1 ]} ( 1 - {P}_{j , j} ) ( 1 - \frac{{Q}_{j , k} + {Q}_{j , k + 1}}{2} ) \vert {L}_{j} \vert , & if x = k \\ 0 , & if x > M - 1\end{matrix}$$

The AMF 130 may determine the number of base stations to transmit a paging message. According to an embodiment of the disclosure, the AMF 130 may determine the number of base stations to transmit a paging message, via a machine learning algorithm. According to an embodiment of the disclosure, the AMF 130 may initiate the machine learning algorithm by configuring an initial value (dⱼ^{(1),*}) of the number of base stations and an initial value (Fⱼ^{(1),*}) of the objective function according to the initial value of the number of base stations. In this case, the number (dⱼ) of base stations may be input data of the objective function. According to an embodiment of the disclosure, the AMF 130 may estimate the number of base stations of a subsequent learning order. For example, a equation for estimating the number of base stations of a subsequent learning order may be defined as follows.

$${d}_{j}^{( t + 1 )} ← {d}_{j}^{( t ) , *} - {η}_{j}^{( t )} g ( {d}_{j}^{( t )} ) \qquad Equation 10$$

Here, nⱼ^{(t)} may be a certain coefficient defined to estimate the number of base stations of a subsequent learning order.

According to an embodiment of the disclosure, the AMF 130 may configure a value of the objective function of a subsequent learning order. According to an embodiment of the disclosure, the AMF 130 may configure a value of the objective function of a subsequent learning order, based on a result of comparing an estimated value of the objective function of the subsequent learning order with a value of the objective function of the current learning order. For example, the AMF 130 may configure, as the value of the objective function of the subsequent learning order, a smaller value among the estimated value (Fⱼ(dⱼ^{(t+1)})) of the objective function of the subsequent learning order and the value (Fⱼ^{(t),*}) of the objective function of the current learning order. For example, since a value of the objective function indicates the number of paging messages, the number (dⱼ) of base stations may be configured in a way that minimizes the value of the objective function. For example, a equation for configuring the objective function of a subsequent learning order may be defined as follows.

$${ℱ}_{j}^{( t + 1 ) , *} ← min \{ {ℱ}_{j}^{( t ) , *} , {ℱ}_{j} ( {d}_{j}^{( t + 1 )} ) \} \qquad Equation 11$$

According to an embodiment of the disclosure, the AMF 130 may determine the number of base stations of a subsequent learning order. According to an embodiment of the disclosure, the AMF 130 may determine the number of base stations of a subsequent learning order, based on a result of comparing an estimated value of the objective function of the subsequent learning order with a value of the objective function of the current learning order. For example, if the estimated objective function of the subsequent learning order is smaller than the objective function of the current learning order, the AMF 130 may determine (dⱼ^{(t+1),*}←dⱼ^{(t+1)}) the estimated number of base stations of the subsequent learning order in Equation 10 to be the number of base stations of the subsequent learning order. For example, since learning has been performed in a way of decreasing the number of paging messages, the AMF 130 may determine the estimated number of base stations of the subsequent learning order to be the number of base stations for subsequent learning. On the other hand, if the estimated value of the objective function of the subsequent learning order is larger than the value of the objective function of the current learning order, the AMF 130 may determine (e.g., dⱼ^{(t+1),*}←dⱼ^{(t),*}) the number of base stations of the current learning order to be the number of base stations of the subsequent learning order. For example, the AMF 130 may not update the number (dⱼ) of base stations when the value of the objective function increases.

According to an embodiment of the disclosure, the AMF 130 may iterate, a designated number of times (e.g., tₘₐₓ), the aforementioned operation for minimizing the number of paging messages. In this case, tₘₐₓ may be a value pre-designated as the number of iterations required to minimize the number of paging messages transmitted by the AMF 130. According to an embodiment of the disclosure, tₘₐₓ may be determined based on the number of base stations included in a TA. According to an embodiment of the disclosure, tₘₐₓ may be determined based on the number of base stations included in a TAL.

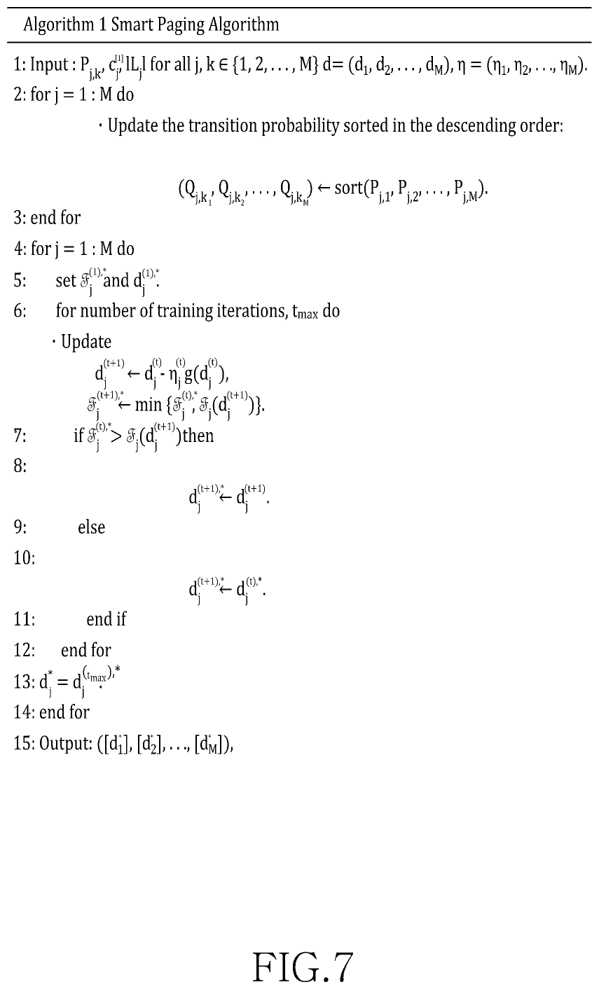

FIG. 7 illustrates a smart paging algorithm according to an embodiment of the disclosure.

Referring to FIG. 7, a paging algorithm for explaining the aforementioned operations of the AMF 130 may be described. The algorithm of FIG. 7 may be referred to as a smart paging algorithm. However, the algorithm is not limited to any one name.

The AMF 130 may identify base stations to transmit a paging message. According to an embodiment of the disclosure, the AMF 130 may identify base stations to transmit a paging message, based on a subsequence sorted in descending order from a base station having a high movement probability and the number of base stations to transmit a paging message. According to an embodiment of the disclosure, a subsequence sorted in descending order from a base station having a high movement probability may be identified for each paging order. According to an embodiment of the disclosure, the number of base stations to transmit a paging message may be identified for each paging order. According to an embodiment of the disclosure, the AMF 130 may transmit paging messages sequentially to identified base stations according to a paging order. According to an embodiment of the disclosure, the paging messages may be transmitted in a broadcasting manner. For example, when first paging fails, the AMF 130 may reduce paging load by transmitting the paging messages only to identified optimal base stations, instead of transmitting the paging messages to all base stations belonging to a TA or a TAL.

The aforementioned operations have been described as being performed by the AMF as a mobility management entity. However, embodiments of the disclosure are not limited thereto. According to an embodiment of the disclosure, another core network entity (e.g., MME) may perform the following operations. In addition, according to an embodiment of the disclosure, some of the aforementioned operations may be performed by the AMF, and others may be performed by an external device (e.g., a server) connected to the AMF. In addition, according to an embodiment of the disclosure, the aforementioned operations, i.e., the order-specific paging base station design operations, may be performed in an external device, and the AMF may acquire and apply only results of the aforementioned operations.

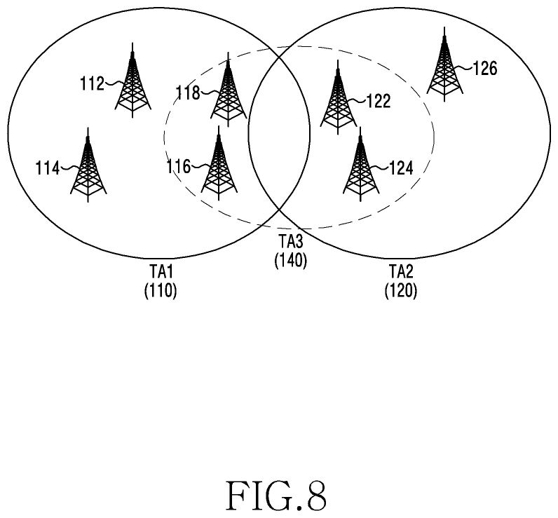

FIG. 8 illustrates candidate TAs via machine learning according to an embodiment of the disclosure.

Referring to FIG. 8, descriptions may be provided for a candidate (or predicted) TA (e.g., TA3) 140 including the base stations (e.g., base stations to which the AMF 130 will transmit a paging message) (including at least one of 116, 118, 124, or 122) identified via the smart paging algorithm of FIG. 7. According to an embodiment of the disclosure, for TA3, a new candidate TA may be identified, the TA including at least one base station identified via the aforementioned procedures (e.g., the smart paging algorithm) among the base stations included in TAL and TA2. In this case, the candidate TA may indicate a TA predicted by the AMF (or MME) via the aforementioned procedures.

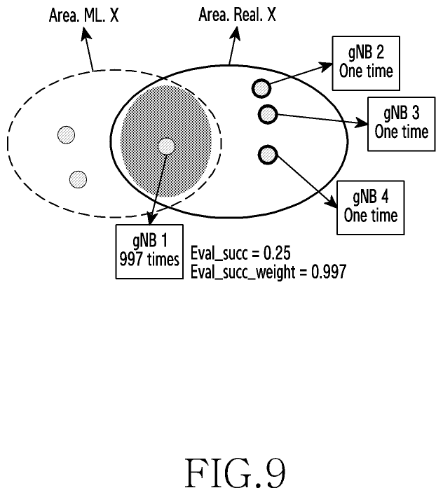

FIG. 9 illustrates performance evaluation results according to an embodiment of the disclosure.

Referring to FIG. 9, methods for evaluating the reliability of the base stations to transmit a paging message, which are derived by the algorithm of FIG. 7, may be described. The methods for evaluating the reliability of the base stations to transmit a paging message may be methods for evaluating performance of the aforementioned machine learning results (e.g., the smart paging algorithm) of FIG. 7. Before evaluating the performance of the machine learning results, the following configurations may be defined.

A source base station (e.g., a source gNB) that provides a service to a UE before the UE moves may be configured to be X. Area.ML.X (e.g., based on gNB X) may indicate a set of predicted gNBs derived via a proposed algorithm (e.g., the smart paging algorithm). For example, Area.ML.X may indicate a set of optimized (or predicted) destination base stations (e.g., destination gNBs) for source gNB X. In addition, Area.Real.X (e.g., based on gNB X) may be a set of base stations to which the UE has actually moved. For example, Area.Real.X may indicate a set of destination base stations (e.g., destination gNBs) that actually have made a paging response to the source base station (e.g., source gNB X). In addition, |·| may indicate a cardinality (or degree) of the set, i.e., the number of elements included in the set. For example, |{gNB1, gNB2}|=2 may be satisfied.

The method for evaluating performance of machine learning results may be expressed as the following equation.

$$Eval\_succ := \frac{\vert ( Area \cdot MLX ⋂ Area \cdot Real \cdot X ) \vert}{\vert ( Area \cdot Real \cdot X ) \vert} ∈ [ 0 , 1 ] \qquad Equation 12$$

(interpretation: the number of gNBs to which the UE has actually moved among gNBs included in the predicted paging area/the number of gNBs to which the UE has actually moved)

Equation 12 may indicate a value obtained by dividing the number of base stations (e.g., gNBs), to which the UE has actually moved, included in the predicted paging area by the number of the base station (e.g., gNBs) to which the UE has actually moved. Eval_succ is evaluation based on the area to which the UE has moved, and may be evaluated via very fast calculation.

$$Eval\_succ \_weight := \frac{\vert {( Area \cdot MLX ⋂ Area \cdot Real \cdot X )}_{w} \vert}{\vert {( Area \cdot Real \cdot X )}_{w} \vert} ∈ [ 0 , 1 ] \qquad Equation 13$$

(interpretation=the total number of times the UE has moved to Area.ML.X∩Area.Real.X/the total number of times the UE has moved to gNB within Area_Real_X)

Equation 13 may indicate a value obtained by dividing the total number of times the UE has moved to base stations, which correspond to the intersection of a set of predicted base stations and a set of base stations to which the UE has actually moved, by the total number of times the UE has actually moved to the base stations. Compared to Equation 12 (e.g., Eval_succ) described above, Eval_succ_weight may be a more accurate performance evaluation method because the total number of actual UE movements is included.

For example, the number of times the UE has moved from gNB X to gNB 1 is 997 in FIG. 9, and when the number of times the UE has moved from gNB X to gNB 1 is 997, Eval_succ may be the number of gNBs existing in the predicted paging area, relative to the number of gNBs to which the UE has moved. Therefore, Eval_succ=1/(1+3)=0.25 may be satisfied. In addition, Eval_succ_weight may be the number of movements belongs to the predicted paging area, relative to the total number of times the UE has moved to another gNB. Therefore, Eval_succ_weight=997/(997+3)=0.997 may be satisfied. Therefore, a result of performance evaluation (e.g., Eval_succ_weight) derived based on Equation 13 may show a more accurate result value compared to a result of performance evaluation (e.g., Eval_succ) derived based on Equation 12.

However, for the performance evaluation method for machine learning, it may not be required to perform evaluation by only Equation 13 described above. In addition, the aforementioned performance evaluation methods are merely examples, and the performance evaluation method for machine learning may be performed by a method other than Equation 12 or 13 described above. In addition, both Equations 12 and 13 described above may be considered as the performance evaluation method.

Evaluation on the predicted paging area via machine learning based on the aforementioned evaluation methods may be performed by an AI model. An AI model for determining reliability of a predicted paging area derived via machine learning may perform an operation for increasing the reliability of the predicted paging area via the aforementioned machine learning based on results of performance evaluation.

According to an embodiment of the disclosure, if a result value of performance evaluation derived by at least one of the aforementioned performance evaluation methods is less than or equal to a certain threshold value (e.g., a minimum performance threshold value determined by a network operator), the AI model may cause the AMF to perform the aforementioned smart paging algorithm again based on more mobility data. For example, the AI model may cause the AMF to derive a new predicted paging area by using mobility data for a longer period than the mobility data used to derive the predicted paging area to be evaluated. In this case, the mobility data for the longer period may indicate mobility data of the UE accumulated over a longer period of time.

According to an embodiment of the disclosure, if the result value of performance evaluation derived by at least one of the aforementioned performance evaluation methods is larger than the certain threshold value (e.g., the minimum performance threshold value determined by the network operator), the AI model may cause the AMF to perform a paging procedure based on the predicted paging area that has already been derived. However, even if the result value of performance evaluation derived by at least one of the aforementioned performance evaluation methods is equal to the certain threshold value, the AI model may cause the AMF to perform a paging procedure based on the derived predicted paging area.

The AI model may determine whether to perform the aforementioned operations, based on requirements including at least one of a certain threshold value, a communication environment of a cell where a UE is located, or an average movement area distribution of UEs. In addition, the AI model may be included in a controller 430 of the AMF, and operations of the AI model may be performed by at least one processor included in the controller 430. Alternatively, the AI model may be included in a network entity included in the AMF separately from the controller 430 of the AMF.

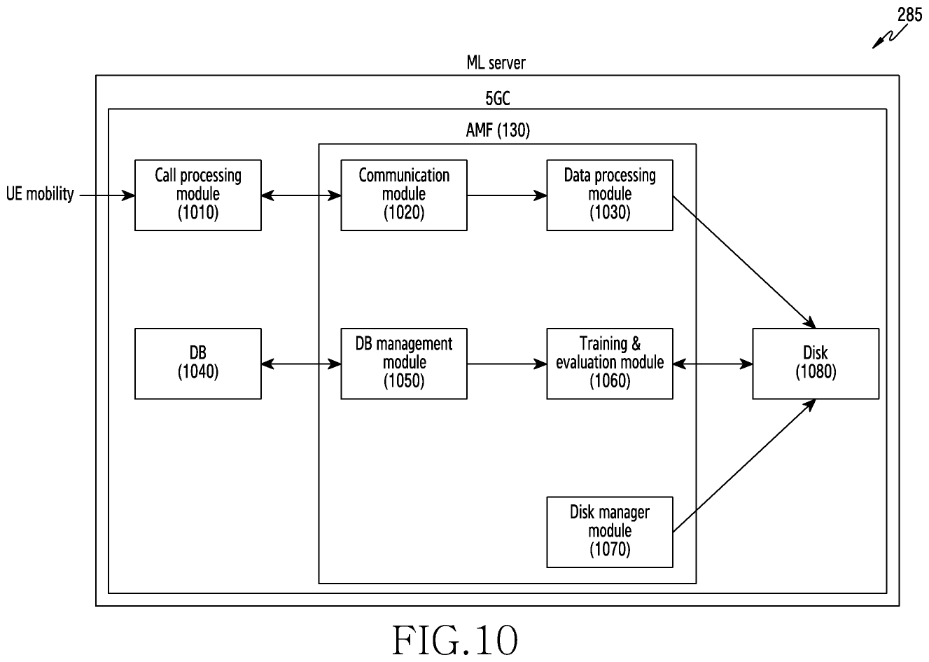

FIG. 10 illustrates a configuration of a network entity 285 for smart paging according to an embodiment of the disclosure.

Referring to FIG. 10, descriptions may be provided to configurations of a network entity (e.g., the controller 430) which performs a smart paging operation and an interaction between the configurations.

A call processing module 1010 may collect mobility of a UE and transfer collected data to a communication module 1020 of a machine learning server (ML server).

The communication module 1020 may transfer, to a data processing module 1030, the collected data (e.g., mobility data) received from the call processing module 1010. In addition, the communication module 1020 may transfer information on a paging area optimized for each base station, which is received from a training & evaluation module 1060, and the like to the call processing module 1010.

The data processing module 1030 may periodically merge the collected data (e.g., the mobility data) received from the communication module 1020 and store the same in a disk 1080.

A DB manager module 1050 may read network configuration information (e.g., including at least one of gNB, TA, or TAL configurations) stored in a DB, and transfer the read network configuration information to the training & evaluation module 1060.

The training & evaluation module 1060 may perform a machine learning algorithm operation and an evaluation operation based on the data stored in the disk 1080. The training & evaluation module 1060 may periodically store predicted paging areas in the disk 1080, and transfer the same to the communication module 1020.

A disk manager module 1070 may periodically delete the data stored in the disk 1080 according to a configured value.

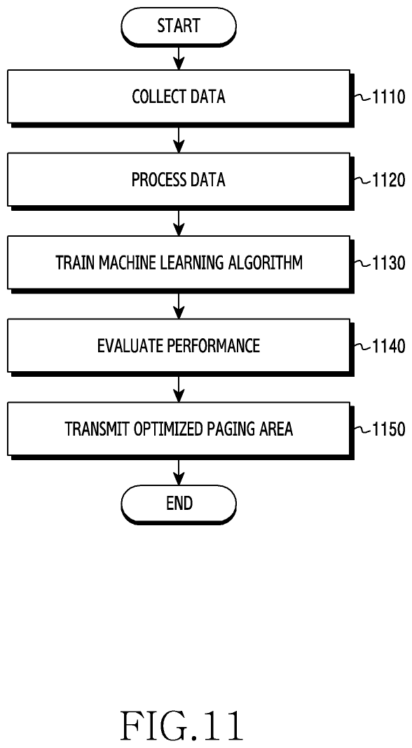

FIG. 11 illustrates an operation sequence of an AMF for smart paging according to an embodiment of the disclosure.

Referring to FIG. 11, descriptions may be provided for a method of deriving an optimal paging area via prediction of base stations to transmit a paging message via machine learning performed by an AMF (or MME) and performance evaluation for a machine learning method.

In operation 1110, the call processing module 1010 may collect mobility data and transfer the same to the communication module 1020. In this case, the data may indicate mobility data that a UE has transmitted via a base station. The mobility data of the UE may be stored in a storage unit 420 of the AMF. Therefore, the mobility data of the UE, which is to be used by the AMF to derive an optimal paging area, may be a part or all of the mobility data stored in the storage unit 420. In addition, an overlap period of the mobility data for deriving an optimal paging area among the mobility data stored in the storage unit 420 may be determined by an AI model.

In operation 1120, the data processing module 1030 may convert the mobility data of the UE into a form for machine learning (e.g., an objective function F(D)). Specifically, the data processing module 1030 may calculate a probability of the UE moving to destination base stations based on a source base station and perform conversion. In addition, the AMF may collect the mobility data to create training data (e.g., Equations 1 to 9).

In operation 1130, the training and evaluation module 1060 may perform the smart paging algorithm of FIG. 7 by using, as input data, refined data output via the communication module 1020. In this case, the data output via the communication module 1020 may have various values depending on an overlap scheme. For example, there may be a scheme of overlapping data collected for a week, a scheme of overlapping data collected for a day, or a scheme of overlapping data equivalent to an amount of three weeks every hour. However, the overlap schemes are not limited to the examples described above, and the data output via the communication module 1020 may be output as values obtained by overlapping in various ways other than the examples described above. The AMF may request additional information (e.g., the number of base stations included in a TAL) required for training from the DB manager module 1050.

In operation 1140, the training and evaluation module 1060 may evaluate, via test data (e.g., the example of FIG. 9), reliability of a predicted paging area derived from the learning algorithm of the data processing module 1030. In this case, an optimized paging area derived via the learning algorithm may be affected by the data overlap scheme. For example, the reliability of the optimized paging area derived via the learning algorithm may differ by at least one of a data overlap period or a unit thereof.

In order to perform the paging procedure based on the derived optimized paging area in operation 1040, information on the derived optimized paging area may be transferred to the call processing module 1010 in operation 1150.

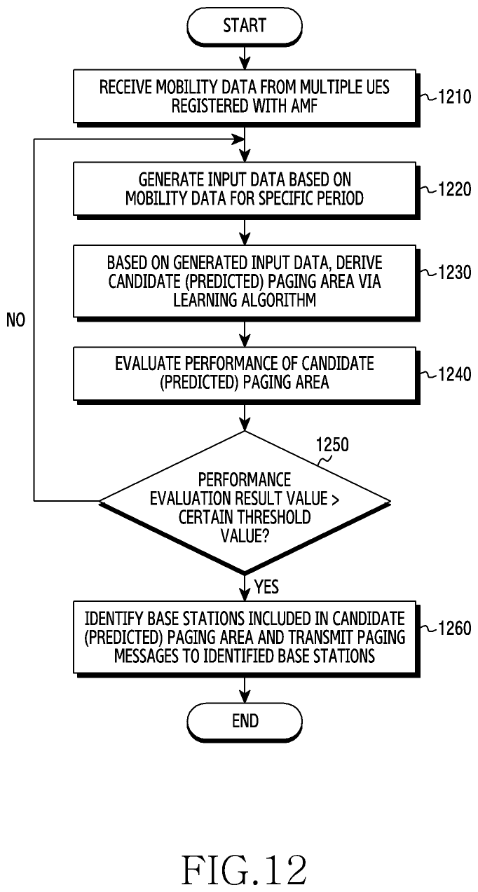

FIG. 12 illustrates an artificial intelligence (AI)-based performance evaluation sequence according to an embodiment of the disclosure.

Referring to FIG. 12, a sequence of AI-based operations of an AMF for deriving an optimized paging area may be described. A machine learning algorithm of FIG. 12 may include an AI model. In this case, the AI model may be a model trained to output a predicted paging area by using mobility data for a predetermined period and input data generated from the mobility data.

In operation 1210, the AMF may receive mobility data from multiple UEs registered with the AMF. For example, the mobility data may include mobility data of the multiple UEs over a specific period in the past (e.g., time before using the learning algorithm for deriving a paging area), for all the multiple UEs registered with the AMF.

In operation 1220, the AMF may generate input data based on the mobility data for the specific period among the collected mobility data. For example, the AMF may select mobility data for a first period from among the received mobility data, and generate the input data based on the mobility data for the selected first period. In this case, the input data may be data that is input to perform the learning algorithm. Alternatively, the input data may indicate training data required for the AI model to derive an optimal predicted paging area based on the learning algorithm.

In operation 1230, the AMF may derive a predicted paging area via machine learning based on the generated input data. The AMF may derive the predicted paging area from the input data based on the mobility data for the first period, by using the learning algorithm trained to derive a predicted paging area based on the mobility data.

In operation 1240, the AMF may perform reliability evaluation on the predicted paging area derived via the machine learning algorithm. According to an embodiment of the disclosure, the AMF may determine reliability of a derived first candidate paging area by using test data for the first period. The test data for the first period may include mobility data related to the multiple UEs after the first period. The mobility data in operation 1210 may include the mobility data for the first period and that for a period after the first period, and the mobility data for the first period may be input to the learning algorithm so as to be used to derive a candidate paging area. The mobility data after the first period may be used to evaluate reliability of a candidate paging area derived from the mobility data for the first period. In this case, the candidate paging area may be used in the same sense as a predicted paging area.

According to an embodiment of the disclosure, operation 1240 may indicate a performance evaluation operation for the learning algorithm for deriving a predicted paging area. Accordingly, the AI model may evaluate the performance of the learning algorithm, and may omit, change, and/or add at least one operation of the smart paging algorithm of FIG. 7.

In operation 1250, the AMF may identify whether a result value of the performance evaluation of operation 1240 has a value larger than a certain threshold value (e.g., a minimum performance threshold value determined by a network operator). If the performance evaluation result value is smaller than or equal to the certain threshold value, the AMF may return to operation 1220 and perform operations (e.g., operations 1220 to 1250) to derive an optimized paging area again based on new mobility data. According to an embodiment of the disclosure, the AMF may select mobility data for a second period from among the mobility data, and generate new input data based on the selected mobility data for the second period. In this case, the mobility data for the second period may indicate data obtained by an overlap (or collection) scheme different from that of the mobility data for the first period, which is used to derive the predicted paging area subject to evaluation. For example, the overlap (or collection) scheme may be at least one of a scheme of varying a collecting period of mobility data or a scheme of varying a unit of a collecting period.

In operation 1260, if the performance evaluation result value is larger than the certain threshold value, the AMF may identify base stations included in the candidate (predicted) paging area and perform a paging procedure by transmitting paging messages to the identified base stations. However, according to an embodiment of the disclosure, even if the performance evaluation result value is larger than the certain threshold value, the AMF may return to operation 1220 according to other requirements (e.g., including at least one of a communication environment of a cell where the UE is located, or an average movement area distribution of the UEs) and perform operations (e.g., operations 1220 to 1250) to derive an optimized paging area again based on new mobility data. In this case, derivation of the predicted paging area and reliability evaluation of the derived paging area may be additionally performed based on mobility data for a third period different from the first period and the second period. According to an embodiment of the disclosure, even if the performance evaluation result value is larger than the certain threshold value, the AL model may omit, change, and/or add at least one operation of the smart paging algorithm of FIG. 7 according to other requirements (e.g., including at least one of a communication environment of a cell where the UE is located, or an average movement area distribution of the UEs). In addition, the AI model may derive an optimal paging area based on the improved smart paging algorithm.

The AI model may include multiple neural network layers. Each of the multiple neural network layers has multiple weight values, and performs neural network calculation via calculation between the multiple weight values and a calculation result of a previous layer. The multiple weight values of the multiple neural network layers may be optimized by learning results of the AI model. For example, the multiple weight values may be updated so that a loss value or cost value acquired by the AI model during a learning procedure is reduced or minimized. The artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the example described above.

If paging fails, the method according to various embodiments of the disclosure can provide an effect of reducing the number of paging messages, when compared to the technology of the related art of sequentially transmitting paging messages to a base station, base stations belonging to a TA, and base stations belonging to a TAL. For example, the method according to various embodiments of the disclosure may reduce the number of paging messages by sorting base stations, to which a UE is highly likely to move, in descending order based on mobility data, and determining the number of base stations to transmit a paging message in a paging order via a machine learning algorithm. Since the number of paging messages required for mobility management is reduced, wired resources and/or wireless resources of a communication network may be operated more efficiently. In addition, in the 5G communication system where the number of base stations included in the same area is larger than that of LTE, a greater advantage in terms of cost may be achieved when the same ratio of performance gain as that of the LTE communication system is obtained.

In addition, a scheme of transmitting paging messages to all base stations belonging to a TA and/or a TAL may cause paging load which may consume a significant portion of network resources. Therefore, descriptions have been provided for a technique of reducing paging load by transmitting paging messages only to a specific number of base stations, to which a UE is highly likely to have moved, via mobility data of the UE and a machine learning algorithm. If the number of paging messages transmitted from an AMF or an MME is reduced, the number of RRC paging messages transmitted from base stations to a UE via a logical channel (e.g., a paging control channel (PCCH)), a transport channel (e.g., a paging channel (PCH)), and a physical channel (e.g., a physical downlink shared channel (PDSCH)) is reduced as a result. For example, according to various embodiments of the disclosure, by reducing the number of unnecessary paging message transmissions, a service quality can be maintained or improved and, at the same time, the efficiency of wired and wireless resources required for the operation of the wireless communication system can be increased. The disclosure has been described based on a static tracking area list (S-TAL), but may also be applicable to a dynamic tracking area list (D-TAL) by extending the machine learning algorithm.

In addition, if a data overlap scheme is diversified via simulation using an AI model, better performance can be achieved in terms of a paging success rate. According to embodiments of the disclosure, a specific number of base stations, to which a UE is highly likely to have moved, may be identified via mobility data of the UE and a machine learning algorithm, and an optimal paging area may be derived by varying a data overlap scheme via a performance evaluation method using an AI model.

A method for identifying a base station to which a network node is to transmit a paging message in a wireless communication system according to an embodiment of the disclosure as described above may include: receiving, from multiple UEs registered with an AMF, mobility data related to movement frequencies of the multiple UEs; based on a learning algorithm trained to derive a candidate paging area based on the mobility data, and mobility data for a first period among the mobility data, deriving a first candidate paging area; determining reliability of the derived first candidate paging area by using test data for the first period; based on the reliability, identifying at least one base station to receive a paging message transmitted from the network node; and transmitting the paging message to the at least one base station, wherein the test data for the first period includes mobility data related to the multiple UEs after the first period.

According to an embodiment of the disclosure, if the reliability is larger than or equal to a certain threshold value, a base station included in the first candidate paging area may be identified as the at least one base station.

According to an embodiment of the disclosure, the method may further include: if the reliability is smaller than a certain threshold value, deriving a second candidate paging area based on the learning algorithm and mobility data for a second period among the mobility data; additionally determining reliability of the second candidate paging area by using test data for the second period; and based on the additionally determined reliability, additionally identifying the at least one base station, wherein the test data for the second period includes mobility data related to the multiple UEs after the second period.

According to an embodiment of the disclosure, the deriving of the first candidate paging area may include: based on the mobility data for the first period, identifying movement probabilities of the multiple UEs between base stations belonging to a TAL; generating an objective function based on the identified movement probabilities; and deriving the first candidate paging area by using the objective function and the learning algorithm.

According to an embodiment of the disclosure, the mobility data for the first period and the mobility data for the second period may be at least one of mobility data collected for different periods or mobility data collected in different time units.

According to an embodiment of the disclosure, the objective function may be generated based on the number of paging messages transmitted by the network node.

According to an embodiment of the disclosure, the identifying of the movement probabilities of the multiple UEs between the base stations belonging to the TAL may include: identifying a base station having transmitted, to the network node, registration request messages received from the multiple UEs; and identifying probabilities that the multiple UEs are to move from a base station registered with the network node to another base station, wherein the another base station is a base station that is not registered with the network node among the base stations belonging to the TAL.

According to an embodiment of the disclosure, the network node may be the AMF or an MME.

A network node in a wireless communication system according to an embodiment of the disclosure as described above may include at least one transceiver, and at least one processor operably coupled to the at least one transceiver, wherein the at least one processor is configured to: receive, from multiple UEs registered with an AMF, mobility data related to movement frequencies of the multiple UEs; based on a learning algorithm trained to derive a candidate paging area based on the mobility data, and mobility data for a first period among the mobility data, derive a first candidate paging area; determine reliability of the derived first candidate paging area by using test data for the first period; based on the reliability, identify at least one base station to receive a paging message transmitted from the network node; and transmit the paging message to the at least one base station, wherein the test data for the first period includes mobility data related to the multiple UEs after the first period.

According to an embodiment of the disclosure, if the reliability is larger than or equal to a certain threshold value, a base station included in the first candidate paging area may be identified as the at least one base station.

According to an embodiment of the disclosure, the at least one processor may be configured to: if the reliability is smaller than a certain threshold value, derive a second candidate paging area based on the learning algorithm and mobility data for a second period among the mobility data; additionally determine reliability of the second candidate paging area by using test data for the second period; and based on the additionally determined reliability, additionally identify the at least one base station, wherein the test data for the second period includes mobility data related to the multiple UEs after the second period.

According to an embodiment of the disclosure, during the deriving of the first candidate paging area, the at least one processor may be configured to: based on the mobility data for the first period, identify movement probabilities of the multiple UEs between base stations belonging to a TAL; generate an objective function based on the identified movement probabilities; and derive the first candidate paging area by using the objective function and the learning algorithm.

According to an embodiment of the disclosure, the mobility data for the first period and the mobility data for the second period may be at least one of mobility data collected for different periods or mobility data collected in different time units.

According to an embodiment of the disclosure, the objective function may be generated based on the number of paging messages transmitted by the network node.

According to an embodiment of the disclosure, the at least one processor may be configured to: identify a base station having transmitted, to the network node, registration request messages received from the multiple UEs; and identify probabilities that the multiple UEs are to move from a base station registered with the network node to another base station, wherein the another base station is a base station that is not registered with the network node among the base stations belonging to the TAL.

According to an embodiment of the disclosure, the network node may be the AMF or an MME.

An AI-related function according to the disclosure is operated via a processor and memory. The processor may include one or multiple processors. In this case, the one or multiple processors may be a general-purpose processor, such as a CPU, an AP, and a digital signal processor (DSP), a graphic-only processor, such as a GPU and a vision processing unit (VPU), or an AI-only processor, such as an NPU. The one or multiple processors control input data to be processed, according to a predefined operation rule or AI model stored in the memory. Alternatively, if the one or multiple processors are AI-only processors, the AI-only processors may be designed based on a hardware structure specialized for processing of a specific AI model.

The predefined operation rule or AI model has been created via training. Here, the creation via training indicates that a basic AI model is trained using multiple pieces of training data via a learning algorithm, thereby creating a predefined operation rule or AI model configured to perform a desired characteristic (or purpose). Such training may be performed on a device itself on which AI is executed or may be performed via a separate server and/or system according to the disclosure. Examples of the learning algorithm include, but are not limited to, supervised learning, unsupervised learning, semi-supervised learning, or reinforcement learning.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in forms and details may be made therein without departing from the spirit and scope of the disclosure as defined by the appended claims and their equivalents.

What is claimed is:

1. A method for identifying a base station to which a network node is to transmit a paging message in a wireless communication system, the method comprising:
receiving, from multiple terminals registered with an access and mobility management function (AMF) entity, mobility data related to movement frequencies of the multiple terminals;
based on a learning algorithm trained to derive a candidate paging area based on the mobility data, and mobility data for a first period among the mobility data, deriving a first candidate paging area;
determining reliability of the derived first candidate paging area based on test data for the first period;
based on the reliability, identifying at least one base station to receive a paging message transmitted from the network node; and
transmitting, to the at least one base station, the paging message,
wherein the test data for the first period comprises mobility data related to the multiple terminals after the first period.

2. The method of claim 1, wherein, in case that the reliability is larger than or equal to a certain threshold value, a base station included in the first candidate paging area is identified as the at least one base station.

3. The method of claim 1, further comprising:
in case that the reliability is smaller than a certain threshold value, deriving a second candidate paging area based on the learning algorithm and mobility data for a second period among the mobility data;
additionally determining reliability of the second candidate paging area based on test data for the second period; and
based on the additionally determined reliability, additionally identifying the at least one base station,
wherein the test data for the second period includes mobility data related to the multiple terminals after the second period.

4. The method of claim 1, wherein the deriving of the first candidate paging area comprises:
based on the mobility data for the first period, identifying movement probabilities of the multiple terminals between base stations belonging to a tracking area list (TAL);
generating an objective function based on the identified movement probabilities; and
deriving the first candidate paging area based on the objective function and the learning algorithm.

5. The method of claim 3, wherein the mobility data for the first period and the mobility data for the second period are at least one of mobility data collected for different periods or mobility data collected in different time units.

6. The method of claim 4, wherein the objective function is generated based on a number of paging messages transmitted by the network node.

7. The method of claim 4,
wherein the identifying of the movement probabilities of the multiple terminals between the base stations belonging to the TAL comprises:
identifying a base station having transmitted, to the network node, registration request messages received from the multiple terminals, and
identifying probabilities that the multiple terminals are to move from a base station registered with the network node to another base station, and
wherein the another base station is a base station that is not registered with the network node among the base stations belonging to the TAL.

8. The method of claim 1, wherein the network node is an access and mobility management function (AMF) entity or a mobility management entity (MME).

9. A network node comprising:
a transceiver;
a processor coupled with the transceiver; and
memory storing instructions that, when executed by the processor, cause the node device to:
receive, from multiple terminals registered with an access and mobility management function (AMF) entity, mobility data related to movement frequencies of the multiple terminals,
based on a learning algorithm trained to derive a candidate paging area based on the mobility data, and mobility data for a first period among the mobility data, derive a first candidate paging area,
determine reliability of the derived first candidate paging area based on test data for the first period,
based on the reliability, identify at least one base station to receive a paging message transmitted from the network node, and
transmit, to the at least one base station, the paging message,
wherein the test data for the first period includes mobility data related to the multiple terminals after the first period.

10. The network node of claim 9, wherein, in case that the reliability is larger than or equal to a certain threshold value, a base station included in the first candidate paging area is identified as the at least one base station.

11. The network node of claim 9, wherein the memory further comprises the instructions, when executed by the processor, cause the network node to:
in case that the reliability is smaller than a certain threshold value, derive a second candidate paging area based on the learning algorithm and mobility data for a second period among the mobility data;
additionally determine reliability of the second candidate paging area based on test data for the second period; and
based on the additionally determined reliability, additionally identify the at least one base station, and
wherein the test data for the second period includes mobility data related to the multiple terminals after the second period.

12. The network node of claim 9, wherein the memory further comprises the instructions, when executed by the processor, cause the network node to:
based on the mobility data for the first period, identify movement probabilities of the multiple terminals between base stations belonging to a tracking area list (TAL);
generate an objective function based on the identified movement probabilities; and
derive the first candidate paging area based on the objective function and the learning algorithm.

13. The network node of claim 11, wherein the mobility data for the first period and the mobility data for the second period are at least one of mobility data collected for different periods or mobility data collected in different time units.

14. The network node of claim 12, wherein the objective function is generated based on a number of paging messages transmitted by the network node.

15. The network node of claim 12,
wherein the instructions, wherein the memory further comprises the instructions, when executed by the processor, cause the network node to:
identify a base station having transmitted, to the network node, registration request messages received from the multiple terminals, and
identify probabilities that the multiple terminals are to move from a base station registered with the network node to another base station, and
wherein the another base station is a base station that is not registered with the network node among the base stations belonging to the TAL.

16. The network node of claim 9, wherein the network node is an access and mobility management function (AMF) entity or a mobility management entity (MME).
